(19) United States
(12) Patent Application Publication
(10) Pub. No.: US 2005/0020249 A1
(43) Pub. Date: Jan. 27, 2005

(54) Automatically response system using a schedule and method thereof

(76) Inventor: Seong-Hwan Seo, Daegu (KR)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/486,923

(22) PCT Filed: Aug. 24, 2002
(86) PCT No.: PCT/KR02/01602

(30) Foreign Application Priority Data
Aug. 24, 2001 (KR) 2001-0051446

(51) Int. Cl. H04Q 7/20

(52) U.S. Cl. 455/414.1; 455/412.1

(57) ABSTRACT

The present invention relates to a communication terminal, and more particularly, to an automatically response method which controls a call requests of sender using the registered schedule in advance. The automatically response method includes registering at least one schedule inputted from recipient, retrieving a schedule information for schedule notice based on at least one schedule, displaying the retrieved schedule information to the recipient, and performing an automatically response to a call requests of sender. Therefore, the invention intercepts a call requests which be telephoned in public place or private time. Also, the invention prevents a misunderstanding between sender and recipient and allows sender to be a call standby effectively, informing sender of the reason why a call is impossible and the available time of calling.

### TECHNICAL FIELD

The present invention relates to communication terminals, and more particularly, to a system and a method thereof are provided to automatically responding to incoming calls according to pre-registered schedules.

With this invention, a receiver can register at least one or more schedules, can search through schedule information for scheduled messages corresponding to at least one or more schedules, can display schedule notices to the receiver, and can automatically respond to callers accordingly; hence, able to prevent undesired call ringing in public places or during private times, and at the same time, able to avoid any misunderstanding between the caller and the receiver by advising of reason for not being able to receive a call and inform next connectable time. This enables the caller to wait in an efficient manner.

### BACKGROUND ART

In these days, accelerating development of telecommunication technology and convenience of telecommunication has resulted in a rapid increase in number of people using phones and cellular phones. Cellular phone has an advantage that it can be used at anytime and on anywhere; hence, it is owned by almost one per person.

Despite the strength that cellular phone can be used irrespective of time and place, cellular phone's bell ringing sound in public places has become a serious pollution problem in our modern times. Especially, in non-allowed public places, such as school, government building, and library, or even in private times when one does not wish to receive a call, such as while sleeping, rest, studying, or driving. phone ringing sound not only bothers cellular receiver but also people around the receiver.

In order to resolve these problems, several techniques such as auto-answering Voice message system and connection disabling system have been developed. Auto-answering system originated from usage in regular wired-phones whereby during receiver's absence, pre-recorded message is played and caller can leave a voice message if needed. Connection disabling system is when a receiver changes cellular phone to non-receiving mode in a public places or where telecommunication signals are fundamentally blocked, calls will not get through to cell phones and hence not cause it to make ringing noise.

However, when call signals are fundamentally blocked, there will be a problem of caller not being able to connect even emergency calls. Also, when Auto-answering system is employed, receiver can only check message left by a caller and cannot proactively respond to caller's request.

On another invention, patent application number 2000-0037072 that is published in Korea, call connection can be controlled depending on a caller's identity. However, this invention has a complexity of requiring each and every caller to be already registered. Furthermore, the above invention cannot handle calls by non-registered callers. And even for registered callers, if their phone numbers change, those callers' call will not be connected unless registered phone number is changed.

On the other hand, aside from techniques to respond to noise pollution, when a receiver determines a schedule for a ringing, there is no means to connect other than receiver's scheduled time.

### DISCLOSURE OF THE INVENTION

Accordingly, several objects and advantages of this invention are:
a) to provide a system or method to automatically respond to a call request made by a caller using schedules.
b) to provide a means to enable a call to come through even in a Do-Not-Disturb scheduled time, using a password that was pre-provided to callers by the receiver.
c) to provide a system or method to deliver appropriate message to a caller whether that be a denial of receiving a call and/or to inform next possible time to receive a call.
d) to provide a system or method thereof to communicate notices to receiver relating to schedule information and Do-Not-Disturb state.

According to a preferred embodiment of this invention, in a call responding system based on schedules, receiver registers one or more schedules, the system searches for schedule information based on one or more registered schedules, schedule the system displays search-resulted schedule notice to receiver, and automatically respond to an incoming call using the schedule.

At least more than one schedule could be monthly schedule, weekly schedule, or special time schedule.

Registering at least more than one schedule means the system provides an input screen corresponding to the receiver-selected schedule menu, and registering the schedule information into a corresponding database.

Searching for schedule information for schedule notice means the system searches at least more than one schedule register with a selected search criteria, checks whether schedule type is “0” or not, checks the status of Do-Not-Disturb times, and if the schedule type is “0” or if Do-Not-Disturb times is past, deletes schedule information from corresponding schedule register. If Do-Not-Disturb time is not past, it maintains the schedule information from corresponding schedule register, and if searching in more than one schedule register is completed, it performs searching in the order of Special time schedule, weekly schedule, and monthly schedule. And it stores search-resulted schedule information into one or more schedule register.

Giving a notice to the Caller means, a) Inquire no. 1 schedule register to check schedule type, b) if that schedule type is not “0”, it checks whether Do-Not-Disturb schedule register is empty, c) if the Do-Not-Disturb schedule register is empty, it stores the schedule register's information into the Do-Not-Disturb register, d) repeat the above steps up to the last schedule register, e) and indicate computed schedule register forms, and if the Do-Not-Disturb schedule register is not empty while repeatedly performing above steps, it compares schedule register's start time to that of the Do-Not-Disturb schedule register.

Automatically responding to a caller's call request means, when a call is made, it checks Do-Not-Disturb schedule register and compares it against the present time. If present time is within Do-Not-Disturb scheduled time, it delivers Do-Not-Disturb state to the caller. And if the caller makes an emergency call request while in a Do-Not-Disturb state, it produces an emergency connection call ringing.

According to additional embodiment of this invention, in a call responding system based on schedules, it provides a communication terminal that enables a means for a receiver to register one or more schedules, to search for schedule information based on one or more registered schedules, to display search-resulted schedule to receiver, to deny caller's request based on current schedule information, to store one or more of the schedules, to temporarily memorize searched schedule information, and to produce a connection call ringing if a caller makes an emergency call request while in a Do-Not-Disturb state.

Stored databases in the communication terminal include Do-Not-Disturb list database, monthly schedule database, weekly schedule database, and special time schedule database.

### BRIEF DESCRIPTION OF INVENTION

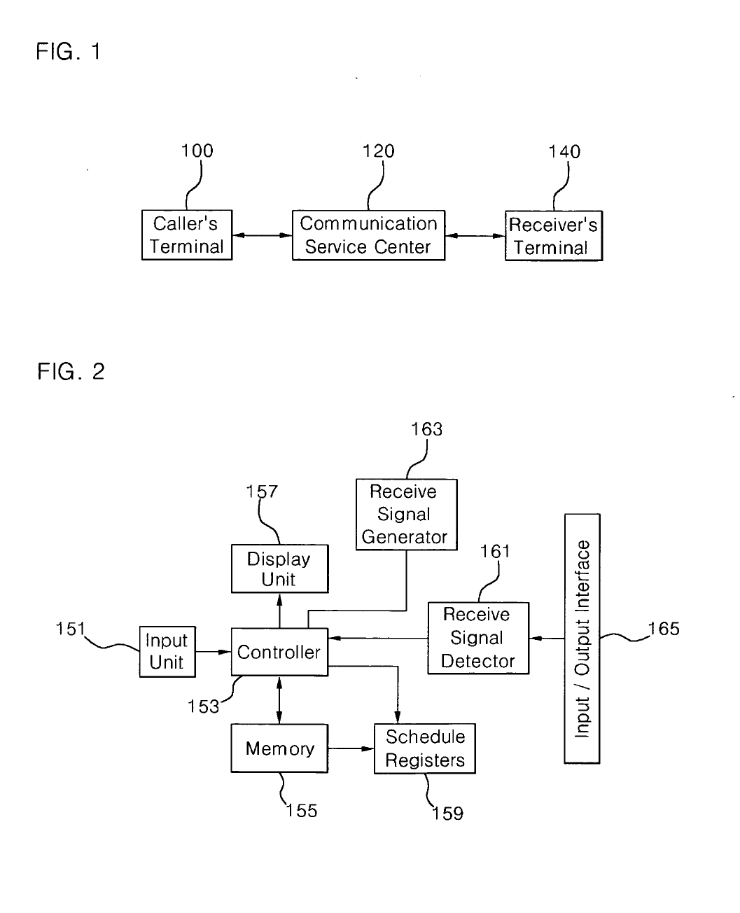

FIG. 1 shows an outline of the call responding system according to a preferred operation scenario with a caller terminal and receiver terminal and a Communication Service Center.

FIG. 2 shows a detailed structure of receiver's Terminal according to the call responding system preferred operation scenario.

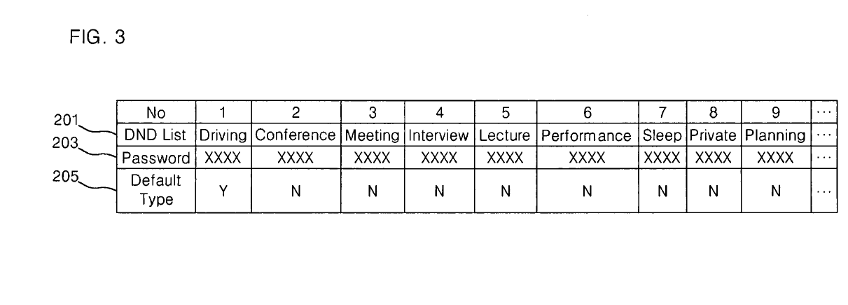

FIG. 3 shows Do-Not-Disturb list database table according to the call responding system preferred operation scenario.

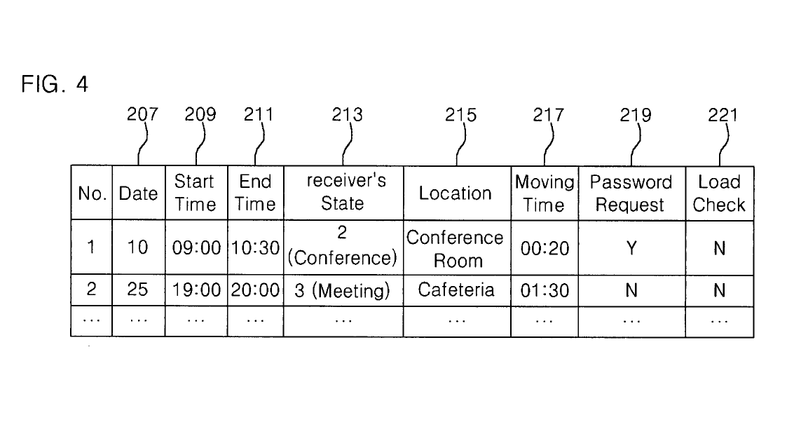

FIG. 4 shows a monthly schedule database table according to the call responding system preferred operation scenario.

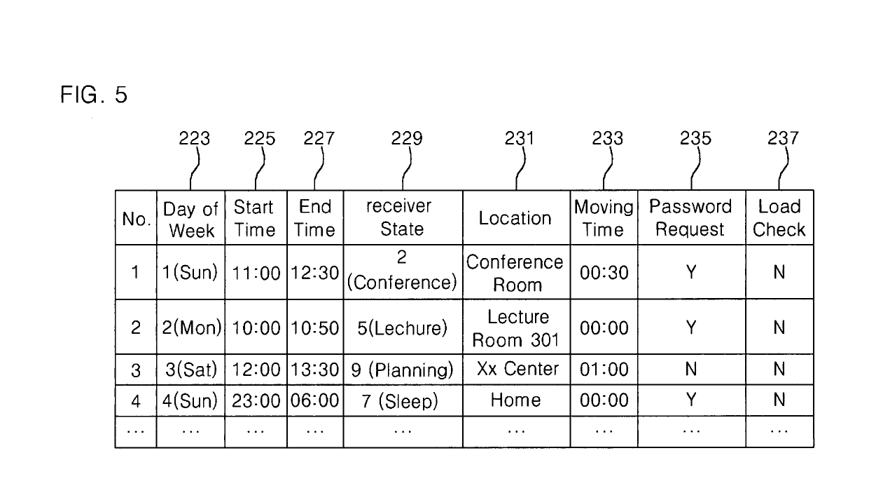

FIG. 5 shows a weekly schedule database table according to the call responding system preferred operation scenario.

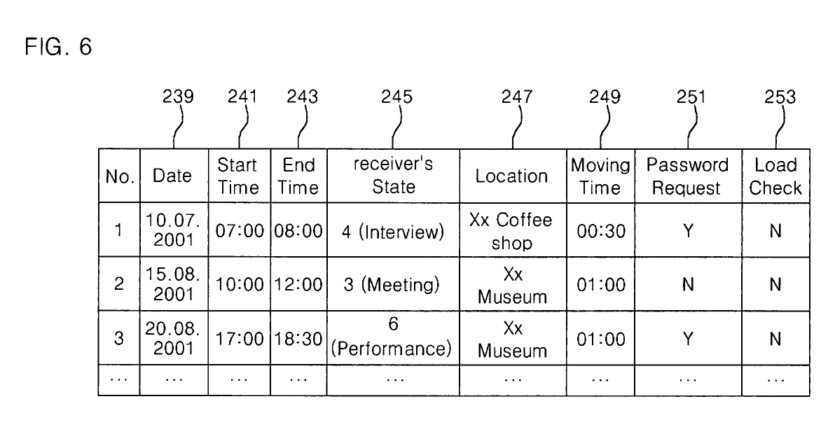

FIG. 6 shows a special-time schedule database table according to the call responding system preferred operation scenario.

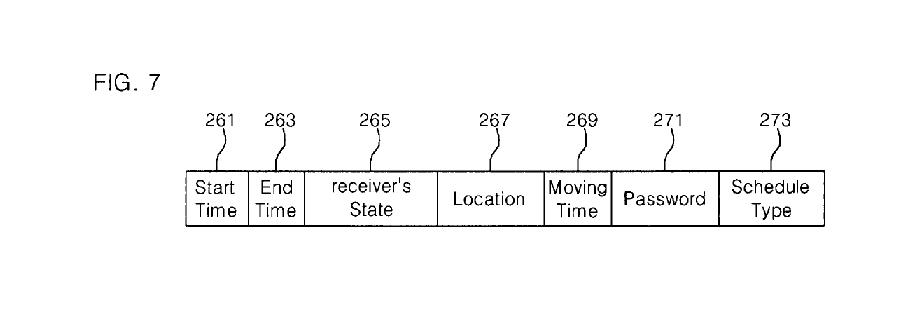

FIG. 7 shows a data structure in schedule register according to the call responding system preferred operation scenario

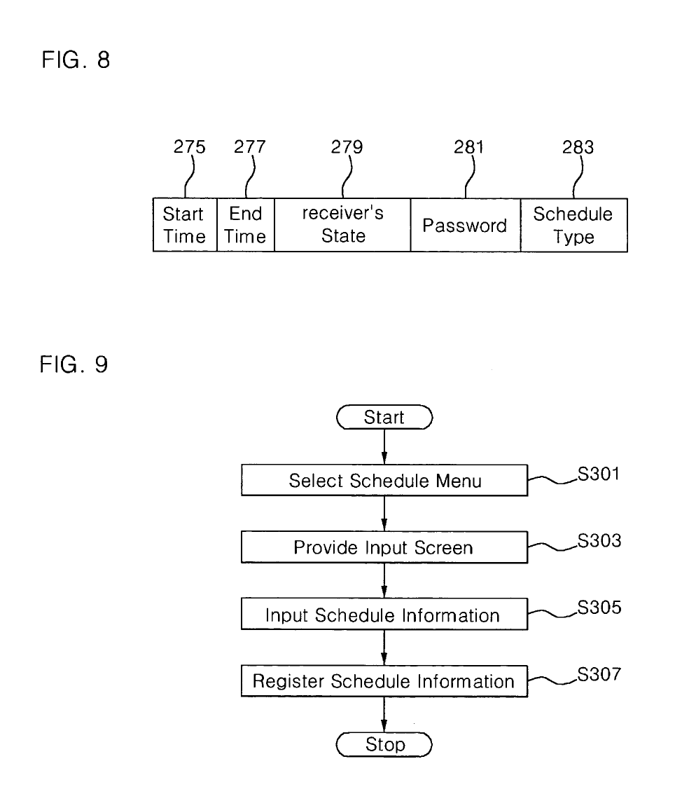

FIG. 8 shows a data structure in Do-Not-Disturb schedule register according to the call responding system preferred operation scenario

FIG. 9 shows a process flowchart of inputting schedule information according to the call responding system preferred operation scenario

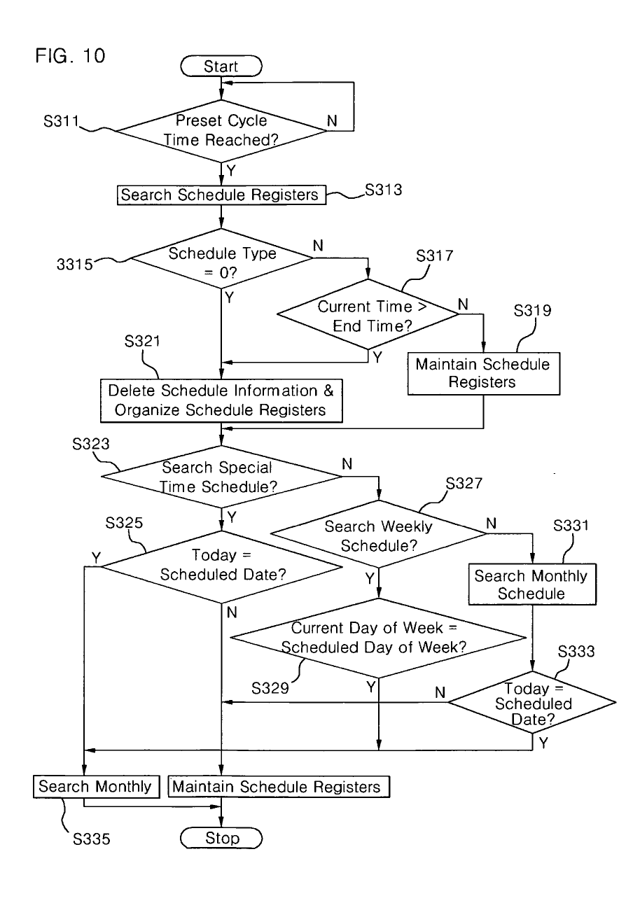

FIG. 10 shows a process flowchart of searching schedule information according to the call responding system preferred operation scenario

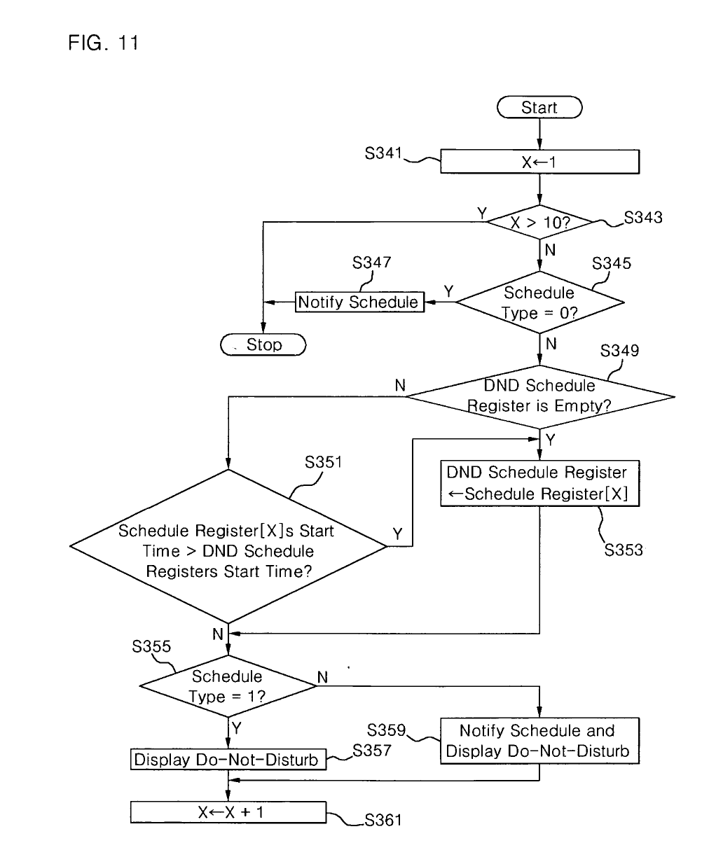

FIG. 11 shows a process flowchart of displaying schedule information and indicating Do-Not-Disturb state according to the call responding system preferred operation scenario

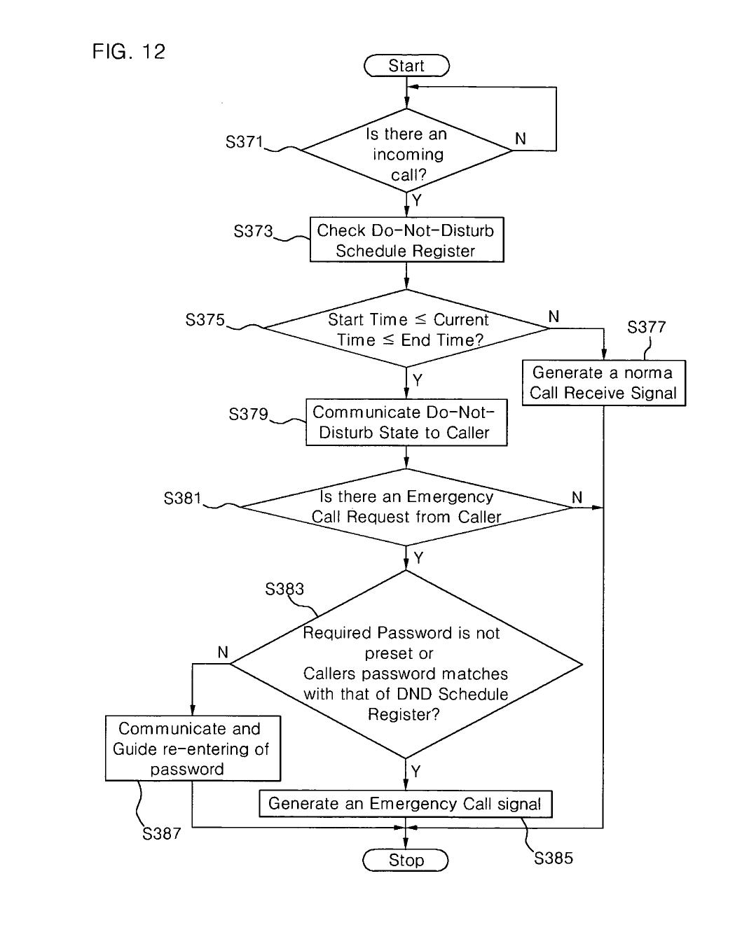

FIG. 12 shows a process flowchart of automatically responding to the Caller corresponding to current Do-Not-Disturb state when a caller makes a call request, according to the call responding system preferred operation scenario

### BEST MODE CARRYING OUT THE INVENTION

The following detailed description will present a preferred embodiment of the invention in reference to the accompanying drawings.

FIG. 1 shows an outline of call responding system according to a preferred operation scenario. In FIG. 1, the call responding system determines Do-Not-Disturb state based on pre-registered schedule when a caller makes a call request. When a call is made within a Do-Not-Disturb period, the call responding system informs the caller of the Do-Not-Disturb state, but when the call is made outside of Do-Not-Disturb time, it produces a ring and connects the call to the receiver.

To achieve this, the call responding system must have a caller's terminal 100 and a receiver's terminal 140 that can request a call and receive a call respectively. In here, the terminals 100 and 140 means either wired or wireless terminals. The wired terminal means a normal house phone. The wireless terminal means PCS, Cellular phone, or a PDA. Also, the call responding system includes a communication service center (CSC) 120 that provides services of registering personal information from the caller or the receiver, connecting a communication channel between the caller and the receiver, and enabling a voice exchange between the caller and the receiver. The CSC 120 in a case of normal house phones means public switched telephone network (PSTN), such as Verizon and AT&T firms. The CSC 120 in a case of wireless network service means wireless service firms, such as Verizon Wireless and Nextel.

The receiver's terminal 140 is explained using FIG. 2. In here, it should be noted that the caller's terminal 100 can be structured the same way as the receiver's terminal 140. The reason to differentiate the caller's terminal 100 and the receiver's terminal 140 is to differentiate a caller and a receiver, and the terminals that caller and receiver carry would have the same functionality and the same structure.

FIG. 2 shows a detailed structure of receiver's Terminal according to the call responding system preferred operation scenario. In FIG. 2, the receiver's terminal 140 encompasses an input unit 151 which is used by receiver to input schedules, and a display unit 157 to show input screen according to receiver's schedule register request. The input unit 151 can be buttons on outside surface of the receiver's terminal 140. The display unit 157 can be a Liquid Crystal Display (LCD) screen to show or any displayable information. Also, the receiver's terminal 140 can include a controller 153, a memory 155, schedule register 159 a receive signal detector 161, a receive signal generator 163, and an input/output interface 165.

The receiver can make a schedule input request using the input unit 151. The controller 153 provides an appropriate input screen to the receiver corresponding to receiver's register request. Hence, the receiver can input desired schedule and have it registered in receiver's terminal 140.

In the memory 155, a procedure for replying a caller's call is stored in a software program format. The memory 155 is also stored with receiver-input schedule; such as Do-Not-Disturb list of database, monthly schedule database, weekly schedule database, and special-time schedule database. Now each database is explained using FIGS. 3 to FIG. 6.

FIG. 3 shows a Do-Not-Disturb list database table 200 according to the call responding system preferred operation scenario. In FIG. 3, the table 200 consists of a Do-Not-Disturb list field 201, a password field 203, and a default code field 205. The Do-Not-Disturb list field 201 contains receiver's list of Do-Not-Disturb events, such as driving, conference, meeting, interview, lecture, show, sleeping, private time, planning time, etc. The password field 203 is filled indivisually with respect to each Do-Not-Disturb event. That means for each Do-Not-Disturb event, a distinct password can be registered. The password field 203 is required for the call responding system to connect a caller with password when the caller requests an emergency call during a Do-Not-Disturb period. In here, the password must be distributed in advance to approved callers corresponding to each Do-Not-Disturb event.

FIG. 4 shows a monthly schedule database table 206 according to the call responding system preferred operation scenario. In FIG. 4, the monthly schedule database table 206 consists of a date field 207, a start time field 209, a finish time field 211, a receiver state field 213, a location field 215, a moving time field 217, a password request code field 219, and a load check field 221. The table 206 may have monthly repeating schedules registered. In here, the receiver state 213 is coded numerically in order to link its relation to the Do-Not-Disturb table database 200. For example, when a receiver's state is ‘conference’, a number ‘2’ is registered, and the number ‘2’ corresponds to ‘conference’ in FIG. 3. When the receiver's state is ‘conference’, password and default code in FIG. 3 corresponding to ‘conference’ are determined. The password request code is used to check whether to allow a caller to make an emergency call ringing or not. For example, if code is ‘Y’, the caller needs to have a password to make an emergency connection. However, if code is ‘N’, the caller does not need a password to make an emergency connection if the caller wishes to. The load-check field 221 is created for a use later on to avoiding duplicating search for information that is already stored in the schedule register 159 when schedules are searched. Furthermore, the load-check field 221 is automatically set to ‘N’ in the beginning. If after a search, schedule information gets to be stored in the schedule register 159, corresponding schedule's load-check field 221 is changed to ‘Y’.

Thereby, the receiver inputs all corresponding fields in the receiver's own monthly schedule, and the monthly schedule is registered in the monthly schedule database 206.

FIG. 5 shows a weekly schedule database table 222 according to the call responding system preferred operation scenario. In FIG. 5, the weekly schedule database table 222 consists of a day-of-the-week field 223, a start time field 225, a finish time field 227, a receiver state field 229, a location field 231, a moving time field 233, a password request code field 235, and a load check field 237. The table 222 may have weekly repeating schedules registered.

FIG. 6 shows a special-time schedule database table 238 according to the call responding system preferred operation scenario. In FIG. 6, the special time schedule database table 238 consists of a date field 239, a start time field 241, a finish time field 243, a receiver state field 245, a location field 247, a moving time field 249, a password request code field 251, and a load check field 253. The table 238 may have non-repeating one-time schedules registered.

Going back to FIG. 2, the controller 153 executes store program in the memory 155. The controller 153 regularly checks registered schedules in the memory 155, and stores schedule information that is needed for schedule notice in the schedule register 159. The controller 153 stores schedule information corresponding to current Do-Not-Disturb schedule separately into the DND schedule register while providing schedule notice information that was stored in the schedule register 159. The controller 153 gives schedule notice based on search result to terminal owner, and provides Do-Not-Disturb status to the caller. The controller 153 searches schedules, and if searched time coincides with schedule notice time, it displays schedule information on the display unit 157, and at the same time, generate schedule notice signals in the receive signal generator 163 in a preprogrammed signal manner. The controller 153 receives a caller's connection request, determines if called time is within a Do-Not-Disturb time period or not, and subsequently sends Do-Not-Disturb state and next connectable time to the caller. The controller 153 could generate connection signal even during a Do-Not-Disturb period when the caller uses a password to request an emergency call.

The schedule register 159 is a temporary memory device to store searched schedule notice from the schedules. The schedule register 159 may include Do-Not-Disturb schedule register that stores separately current Do-Not-Disturb status schedule. Although the call responding system in this invention uses 10 schedule registers and one Do-Not-Disturb register, depending on this invention's alternatives, it can use more than 10 schedule registers.

FIG. 7 and FIG. 8 illustrates data structure of the schedule information in the schedule register 159.

FIG. 7 shows a data structure 260 in the schedule register 159 according to the call responding system preferred operation scenario. In FIG. 7, the data structure 260 consists of a start time field 261, a finish time field 263, a receiver state field 265, a location field 267, a moving time field 269, a password field 271, and a schedule type field 273. In here, the start time field 261, a finish time field 263, a receiver state field 265, a location field 267, and a moving time field 269 can be copied directly from the memory 155 and be stored. The password field 271 is set to ‘0000’ if password request field in database is ‘N’. If password request field in database is ‘Y’, a password corresponding to the password request field may be copied and be stored in the password field 271. The schedule type field 273 contains a number depending on simple schedule notice or Do-Not-Disturb status indicating mode; namely, ‘0’ for simple schedule notice, ‘1’ for Do-Not-Disturb state indication, and ‘2’ for schedule notice and Do-Not-Disturb state indication. For example, if Do-Not-Disturb state indication is selected, ‘1’ will be stored in the schedule type field 273.

FIG. 8 shows a data structure 274 in Do-Not-Disturb schedule register according to the call responding system preferred operation scenario. The Do-Not-Disturb schedule register is included in the schedule register 159 in FIG. 2. In FIG. 8, the data structure 274 consists of a start time field 275, a finish time field 277, a receiver state field 279, a password field 281, and a schedule type field 283. In here, data input storage method for each category is the same as the storage method of the above schedule register; except in the Do-Not-Disturb schedule register, only fields that are required for connection denial are stored; the start time field 275, the finish time field 277, the receiver state field 279, the password field 281, and the schedule type field 283. Hence, only current Do-Not-Disturb schedule information is stored. Hence, when there is a call request, only Do-Not-Disturb schedule register need to be checked to respond appropriately and promptly. Without this register, the system must search all schedule registers every time a call request is received.

In order to either display Do-Not-Disturb state status on the display unit 157, or effect “one-touch Do-Not-Disturb selection”, the Do-Not-Disturb schedule register is required. The data that “one-touch Do-Not-Disturb selection” process requires is the data in the Do-Not-Disturb schedule register in FIG. 8. In a preferred scenario, ‘*’ button is for disabling Do-Not-Disturb schedule, ‘#’ button is for enabling Do-Not-Disturb schedule with a set of default values (current time to start time, ‘start time+increase time’ to finish time, default to receiver's state, ‘0000’ to password, ‘1’ [Do-Not-Disturb selection] to schedule type) . Additionally, ‘Δ’ and ‘←’ buttons are for moving Do-Not-Disturb schedule items, and ‘↑’ and ‘↓’ buttons are for changing each item's values. If a schedule already exists for the time that a user wishes to change, then only finish time, receiver state, and password can be modified. Now the only additionally required data is Do-Not-Disturb Increase time, and this value shall be determined by a value in the password 203 field under category ‘planning (9)’ in Do-Not-Disturb list 201 from the FIG. 3. That is because ‘planning’ is for schedule notice and does not need to use a password.

The usage of the schedule registers and the Do-Not-Disturb schedule register 159 define a class structure of memory 155. That is, the schedule registers resides in the memory 155's upper structure, and the Do-Not-Disturb schedule register resides in the schedule register's upper structure. This is to minimize a time required to quickly determine a status of Do-Not-Disturb state when a call request is received. If the schedule register does not exist, all schedule information in memory 155 must be searched. And if Do-Not-Disturb schedule register does not exist, not only all schedule registers must be searched but also “one-touch Do-Not-Disturb selection” will be difficult to achieve.

Referring back to FIG. 2, the receive signal detector 161 searches for caller's connect request ring signal through input/output interface 165. When a ring signal is detected, the receive signal detector 161 conveys this information to the controller 153.

When a caller uses a password to request an emergency call, the receive signal generator 163 produces an emergency call receive ring signal after receiving a control signal from the controller 153. The emergency call receive signal could be quieter than a normal receive signal as not to disturb public atmosphere in a Do-Not-Disturb state. It could also be a Silent-mode ring. The volume of the connect call signal can be preset in the program and can be controlled by the controller 153.

One should note that the call responding system could be embodied within the CSC 120 instead of within the receiver's terminal 140. That means the organization and the functionalities of the controller 153, the memory 155, and the schedule register 159 can be achieved within the CSC 120 to effect the call responding system. In this case, call responding system can be provided to more callers with a better service. For example, one can use Internet or PDA to directly schedule CSC 120's computer system database, and better additional functionalities can be added.

FIG. 9 shows a process flowchart of inputting schedule information according to the call responding system preferred operation scenario. A receiver who has purchased the call responding system needs to register monthly, weekly, special time schedules into receiver's terminal. But before registering monthly, weekly, special time schedules, the receiver must register Do-Not-Disturb list items. In FIG. 9, the receiver first selects a schedule menu (step 301). Then, the receiver's terminal displays an input screen to the receiver corresponding to the selected menu (step 303). The receiver inputs schedule information through the input screen (step 305). In this step, schedule information would include day-of-the-week, date, start time, finish time, receiver state, location, moving time, password, etc. Then the receiver terminal registers the schedule information to corresponding databases (step 307). If the schedule information is for monthly schedule, the receiver's terminal registers the schedule information into the monthly schedule database, and if the schedule information is for weekly schedule, the receiver's terminal registers the schedule information into the weekly schedule database. Also the receiver can input Do-Not-Disturb state, password, and default type; hence registering into the Do-Not-Disturb list database.

FIG. 10 shows a process flowchart of searching through schedule information according to the call responding system preferred operation scenario. Assuming that all schedules in the receiver terminal are registered, auto-responding process is automatically executed from the moment that the receiver terminal's power is turned on.

FIG. 10 shows that when the receiver terminal's power is turned on, the receiver terminal starts the schedule searching process. Firstly, the receiver terminal monitors whether current time is within a preset searching cycle time (step 311). In here, the searching cycle time is modifiable, and it is preferred that it be set in 1-minute unit; thereby, the receiver terminal executes schedule searching process. Secondly, the receiver terminal searches through the schedule register (step 313). In here, the schedule information includes start time, finish time, receiver state, location, moving time, password, and schedule type of which all are illustrated in FIG. 7. This schedule searching process is for deleting schedule information that is stored in the schedule register if current time is past its finish time. For example, if current time is 11:33AM and the schedule register's stored schedule information's finish time is 11:30AM, then the schedule information does not need to be stored in the schedule register anymore; hence, it may be deleted. The receiver terminal checks whether the schedule type is ‘0’ (step 315), and if it is not ‘0’ , it checks whether current time is past finish time. (step 317). If the schedule type is ‘0’ or if current time is past finish time , the receiver terminal deletes schedule information from the schedule register (step 321). If current time is not past finish time, the receiver terminal maintains the schedule register's schedule information (step 319). The steps from 313 to 321 are repeated for all schedule registers.

When searching in schedule registers is completed, the receiver terminal searches special-time schedule (step 323). In here, the special-time searching can be executed using schedule information that is registered in the special-time schedule database. The receiver terminal checks whether current date is the same as the scheduled date (step 325). If these are the same, the receiver terminal executes ‘schedule information treatment’ on corresponding schedule information (step 335). If these are different, the receiver terminal executes ‘schedule information maintain’ step (step 337).

After special-time schedule searching is completed, the receiver terminal searches weekly schedules (step 227). It compares current day against a scheduled day (step 329). If these are the same, it executes the step 335; but if these are different, it executes the step 337.

After weekly schedule searching is completed, the receiver terminal searches monthly schedules (step 331). It compares current day against a scheduled day (step 333). If these are the same, it executes the step 335; and if these are different, it executes the step 337.

These steps are executed for all information in all types of schedule databases.

In “schedule Information Treatment” process (step 335), for items with load-check is ‘N’, it searches through schedules that have current time within the schedule's start and finish time. Therefore, the number of schedule registers is determined by the number of schedules that could be planned to have the same times. In our system's case, it would be possible to have 10 schedule registers that could have the same time (in minute unit). For loaded schedule information, load-check is set to ‘Y’, and schedule type is set. Schedule type is set to 0 if receiver state is ‘planning’ (in FIG. 3 receiver state is ‘9’) as this is for ‘simply schedule notice’. If moving time is ‘0:00’ and place requires privacy, this situation is Do-Not-Disturb and schedule type is set to 1. Finally, the schedule type is set to 2 if there exists moving time and place is private as this situation is Do-Not-Disturb and is in a schedule notice mode.

In ‘schedule information maintain’ step 337, all schedule information's load-check value is set to ‘N’. This has a meaning of initializing next schedule search towards once-loaded schedule register's information on a special day.

FIG. 11 shows a process flowchart of displaying schedule information and indicating Do-Not-Disturb state according to the call responding system preferred operation scenario. Updated schedule information that resulted from the schedule searching process can be notified to the receiver as well as displayed of its Do-Not-Disturb state. As mentioned earlier, this invention consists of 10 schedule registers and one Do-Not-Disturb register. In FIG. 11, one can see that the receiver terminal checks updated schedule registers sequentially (step 341). The receiver terminal checks if 10^{th} schedule register is checked yet (step 343), and if not, it checks if the first schedule register's schedule type is ‘0’ (simple schedule notify) (step 345).

If the schedule type is not ‘0’, it checks whether Do-Not-Disturb schedule register is empty (step 349). If the Do-Not-Disturb schedule register is empty, the receiver terminal copies schedule information from the first schedule register to the Do-Not-Disturb schedule register (step 353). In a case that the Do-Not-Disturb schedule register is not empty, the receiver terminal compares first register's start time against the Do-Not-Disturb schedule register (step 351).

If the Do-Not-Disturb register's start time is later than that of the schedule register, the Do-Not-Disturb schedule register's information is copied from that of schedule register (step 353). If the Do-Not-Disturb register's start time is not later than that of the schedule register, the receiver terminal goes on to check if the schedule type is ‘1’ or not (step 355). If it is ‘1’, the receiver terminal sets itself to the Do-Not-Disturb state (step 357), and if it is not ‘1’, the receiver terminal sets itself to the schedule notice and a Do-Not-Disturb state (step 359).

After the first schedule register's schedule notice Do-Not-Disturb state setting is completed, second schedule register is checked (step 361). And the above steps from 343 to 361 are repeated until the last schedule register is checked.

When schedule type is ‘0’ in the step 345, the receiver terminal sets itself to schedule notice only (step 347).

The result from checking first schedule register to last schedule register can be displayed to the receiver, and at the same time, receiver signal be generated. In here, the schedule notice means communicating corresponding schedule information. The Do-Not-Disturb status displayed items include receiver state, Do-Not-Disturb time, password request status on corresponding schedule information. The Do-Not-Disturb time is calculated by subtracting current time from finish time.

FIG. 12 shows a process flowchart of automatically responding to a Caller corresponding to current Do-Not-Disturb state when a caller makes the call request, according to the call responding system preferred operation scenario. FIG. 12 shows that this process starts with receiver terminal checking to see if there is any call request (step 371); this check for call request is done using ring signal. When there is a call request, the receiver terminal checks the Do-Not-Disturb schedule register (step 373), and determines if current time is between start time and finish time (step 375). After the comparison, if current time has past the finish time, the receiver terminal generates a receive signal and alerts the receiver via either a ring sound or a vibration (step 377). If current time is within start and finish time, it communicates to the caller its current Do-Not-Disturb status (receiver state and call possible time, etc.) via either text message or voice message (step 379).

The caller may still wish to connect and make an emergency call request even after learning of Do-Not-Disturb state. At this time, an emergency call connection can still be achieved. The receiver terminal checks to see if the caller is making an emergency call request (step 381). If there is an emergency call request, the receiver terminal checks if the caller's selected password matches with that of Do-Not-Disturb schedule register (step 383). The step 383 also applies to cases when password is not setup or password is ‘0000’. After checking, if the password is correct or if password is not setup or password is ‘0000’, the receiver terminal generates an emergency call receive signal (step 385), if password is required but is not correct, it communicates to the caller to re-input a password and provide a helpful guide information (step 387). Thereby, the receiver learns of an emergency call request in the step 385, and answer the call. Through the step 387 the caller can re-input a correct password to make an emergency call request.

On an alternative embodiment of this invention, by receiver registering schedule information ahead of time, if the receiver does not wish to answer any call, the receiver does not have to answer calls using this Do-Not-Disturb functionality.

This invention can be applied such that by receiver register certain undesired people's phone numbers in advance, a system can be used such as to block any calls coming from these people.

Industrial Applicability

From the description above, a number of advantages of Auto Responding System by Schedule (call responding system) become evident:
(a) By automatically answering calls using schedules, undesired call ringing can be prevented while in a public place or during a private time.
(b) By informing the caller as to the exact reason for not answering the call as well as informing the next possible call receive time, any misunderstanding between the caller and the receiver can be prevented.
(c) By enabling to have selective emergency calls to be received even during a Do-Not-Disturb time, absolutely imperative calls can reach the receiver regardless of Do-Not-Disturb settings.
(d) By notifying the receiver of current schedule or current Do-Not-Disturb state, communication system's usage is maximized.

This invention is applicable for both wire and wireless terminals.

The call responding system can be supplied either by a communication service provider or by a terminal manufacturer.

Although the description above contains many specificities, these should not be construed as limiting the scope of this invention. Also, on the above technical field, any person with some communications knowledge can change or modify this invention without going outside of the scope limits of this invention.

1. A call responding method based on schedules, comprising:
registering at least one or more schedules input by receiver;
searching schedule information based on at least one said schedule;
displaying to said receiver said searched schedule information; and
automatically responding to a caller's call request.

2. The call responding method according to claim 1, wherein at least one or more schedules is a monthly schedule, a weekly schedule, a special time schedule.

3. The call responding method according to claim 1, said step for registering a receiver-input of one or more schedules comprises the steps of:
providing a corresponding input screen for the receiver's selected schedule menu;
recognizing schedule information input through said input screen; and registering said schedule information to a corresponding database.

4. The call responding method according to claim 1, said step for searching schedule information based on at least one said schedule comprises the steps of:
searching one or more schedule registers at every preset searching cycle;
checking whether schedule type is ‘0’ and the status of Do-Not-Disturb time;
deleting schedule information from corresponding schedule register if said schedule type is ‘0’ or if said Do-Not-Disturb time is past;
searching in order of special time schedule, weekly schedule, and monthly schedule after said step of searching one or more schedule register is completed; and
storing search-resulted schedule information into one or more schedule registers.

5. The call responding method according to claim 4, wherein said Do-Not-Disturb time is calculated from current time and a finish time.

6. The call responding method according to claim 4, further comprising the step of:
maintaining said schedule register's schedule information in a case that said Do-Not-Disturb time is not past.

7. The call responding method according to claim 1, said step for displaying to said receiver said searched schedule information comprises the steps of:
confirming schedule type by checking number 1 schedule register;
checking said Do-Not-Disturb schedule register is empty in a case that said schedule type is not ‘0’;
storing schedule register's schedule information in a case that said Do-Not-Disturb schedule register is empty;
repeating above steps for each schedule register to the last schedule register; and
displaying computed result corresponding to said schedule type.

8. The call responding method according to claim 7, further comprising the step of: comparing schedule register's start time against Do-Not-Disturb schedule register's start time in a case that said Do-Not-Disturb schedule register is not empty, while repeating above said steps.

9. The call responding method according to claim 7, wherein said searched result is at least one of schedule notify, Do-Not-Disturb state signal, or schedule notify & Do-Not-Disturb state signal.

10. The call responding method according to claim 1, the step for automatically responding to a caller's connect request comprises the steps of:
checking Do-Not-Disturb schedule register to compare current time against Do-Not-Disturb start time, in a case that there is a caller request for a call;
communicating Do-Not-Disturb status and possible receive time to said caller, in a case that said current time is within said Do-Not-Disturb time; and
producing emergency call signal ring, in a case that said caller makes an emergency call request while in a Do-Not-Disturb state.

11. The call responding method according to claim 10 wherein said emergency call request is executed with a password input.

12. A communication terminal, comprising:
means for registering a receiver-input of at least one or more schedules;
means for searching schedule information based on at least one said schedule;
means for displaying to said receiver said searched schedule information;
means for denying connection to a caller's call request, based on current time's schedule information; and
means for storing and register at least one said schedule.

13. The terminal according to claim 12, further comprising:
means for temporarily memorizing schedule information resulted from said means to search.

14. The terminal according to claim 12, the means for storing includes Do-Not-Disturb list database, monthly schedule database, weekly schedule database, and special time schedule database.

15. The terminal according to claim 12, further comprising:
means for producing an emergency call signal ring during a Do-Not-Disturb state, if said caller makes an emergency call request.

16. The terminal according to claim 15, wherein the emergency call request is executed with a password input.

17. The terminal according to claim 12, wherein said means to register includes a means to set a Do-Not-Disturb time with “one-touch”.
